(19) United States
(12) Patent Application Publication
(10) Pub. No.: US 2007/0149273 A1
(43) Pub. Date: Jun. 28, 2007

(54) Slide show in a video slot gaming machine

(76) Inventor: John Livingston, stateline, MN (US)

Correspondence Address: John Livingston, PO Box 5154, Stateline, NV, 89449, US

(21) Appl. No.: 11/318,942

(22) Filed: Dec. 27, 2005

(51) Int. Cl. A63F 13/00

(52) U.S. Cl. 463/20

(57) ABSTRACT

A video slot gaming machine includes a display device. On the display device images of the game symbols for a video slot game being played are superimposed over the slide show image instead of the simulated reels of a mechanical slot machine. As the game is being played the slide show images will change.

### REFERENCE TO CD

This specification includes a code appendix which is filed herewith. The computer source code comprising one embodiment of the computer readable instructions which may be used to practice an embodiment of this invention, and which are hereby incorporated into this specification by this reference. Contents of two identical compact discs:

| | | |
|---|---|---|
| slotc.cpp | Nov. 13, 2005 | 795 |
| slotc.h | Nov. 13, 2005 | 601 |
| slotdlg.cpp | Nov. 19, 2005 | 26489 |
| slotdlg.h | Nov. 19, 2005 | 4181 |
| stdafx.cpp | Oct. 24, 2005 | 207 |
| stdafx.h | Nov. 13, 2005 | 407 |

### BACKGROUND

The current video gaming machines simulate mechanical slot machines. Manufacturers of these machines need to add interest to the games provided on such machines in order to keep the players amused and therefore willing to continue playing the game. There seems to be a tendency towards more visual enhancement.

The invention provides a different approach to visual enhancement on such a machine.

### SUMMARY

The invention displays a slide show as the screen background for a video slot game as a player plays. It was created with the thought that players that come to the Lake Tahoe area (or other areas with casino gaming) could view some of the spectacular scenery while playing a slot machine. The changing background images and animated game symbols provide added visual enhancement. There is also the added advantage of gaining knowledge of the local area during game play. Even if a player losses they may feel they came away with more than the thrill of the chance of winning.

The invention could also be used for virtual tour of casino itself. If jackpot were a vacation, slide show of vacation destination.

### DRAWING DESCRIPTION

FIG. 1: Video screen with all game objects displayed in full size, all overlaying a slide show image.

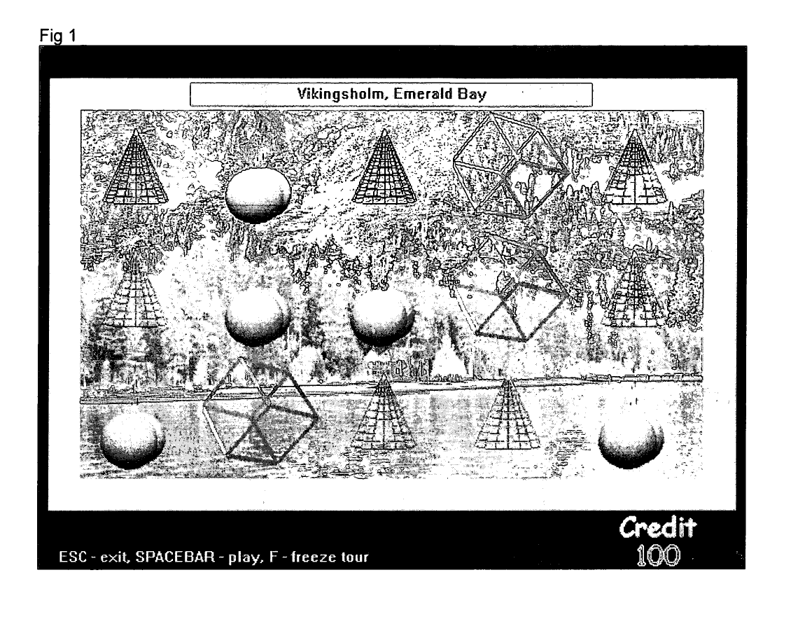

FIG. 2: Video screen with some game objects in full size and others scaling in, all overlaying a slide show image.

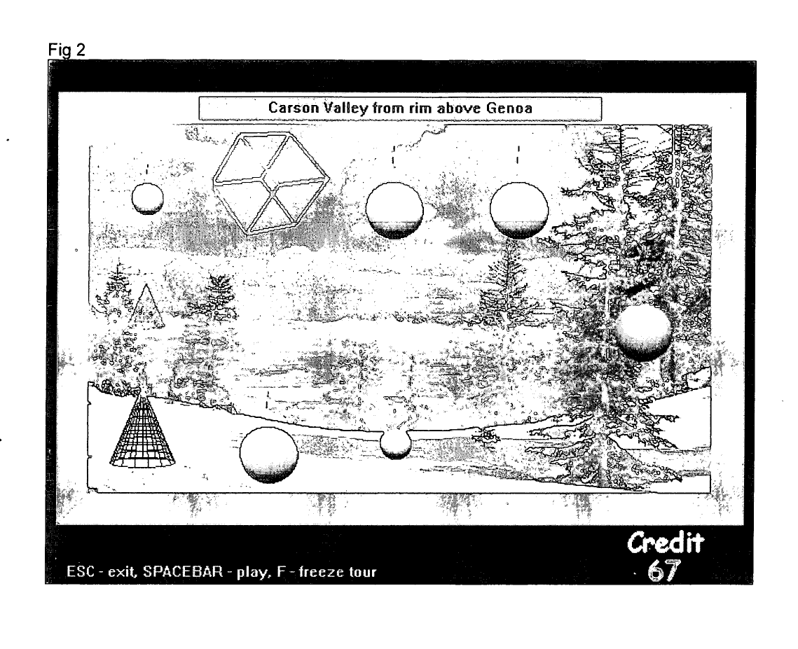

### DETAILED DESCRIPTION

Slide show images are displayed in the video screen of the video slot gaming machine with the game symbols overlaying the slide show images. Game symbols are changed by some method when the player signals the machine to do so by a handle pull, button press or other means. During game play the slide show images will change when a time interval has passed, after a certain amount of handle pulls or other method. A method for doing this is described below as well as with the code on the reference CD.

The slide show image list is loaded during program initialization. This list contains image time change interval, image filenames and descriptions to display with each image. Primary and back screen buffers are initialized during program initialization. Image frame and description plaque are drawn along with anything else that may be needed.

Image loading is done a small amount at a time so as not to slow down visual affects of game symbols noticeably. It would also be possible to load entire image when there are no game symbols displayed on the screen. Current configuration loads the bitmap header and color map first then 8 scan lines at a time until done loading. These calls are made every 3 frame redraws. Bitmap format is 8 bit with size of 560×336. This data is converted into a 24 bit format with use of the color map. The bitmap size of 560×336 allows for game matrix element size of 112×112 for a game matrix of 5×3. These parameters can be changed depending on needs and performance requirements.

Panarama images are implemented by using more than one image and panning one column per frame redraw.

Game symbols are loaded during program initialization. Each game symbol buffer has a header with an array of 72 offsets to the 72 different 3D representations within that buffer.

Each representation within the buffer is of the following form:

height of representation (first line+height is a value of 112 or less)

first line (top position, blank lines would be above)

first column (left position, blank columns would be to the left)

width of representation (first column+width is a value of 112 or less)

representation for each scan line (count byte; if count byte is >128 then color data else blank; if color subtract 128 from count for count of RGB values to follow; if blank then amount of blanks before next color and next byte in buffer is another count)

There are four phases of play. Phase 1 all symbols are drawn on the screen in normal size. Phase 2 symbols are dropped of the screen. Phase 3 symbols are redrawn onto the screen scaling from small to large to give the impression of coming out of the background and into the forground. Groups of 3 randomly selected symbols at a time are scaled until all are of full size. Symbols go from size 0 to 112 in increments of 12.

During Phase 4 checks are made for pays on bet lines and indicated.

Slide show image changes are made between phase 2 and 3 when time interval for change has passed and new image has been loaded. When change is made a new image description is displayed.

During drawing, a slide show image is copied onto a buffer. Game symbols are then superimposed over this buffer. When blank data is indicated the slide show image data is not changed and when symbol data is indicated slide show image data is overwritten. When all game symbols have been superimposed the buffer is written to one of the screen buffers and screen buffers are swapped.

1. A slide show in a video slot gaming machine as the screen background for the game symbol screen area of any video slot game, wherein game symbols are arranged on the screen in a grid having a plurality of rows and columns; game symbols are used to determine outcome based on a pay table and predetermined pay lines.

2. A method in a video slot gaming machine as recited in claim 1 for displaying a slide show, wherein game symbols are overlayed over a slide show image giving them a 3d look and animation, game symbols are changed by dropping them off the screen and scaling new ones in from small to full size.
